(19) United States
(12) Patent Application Publication
(10) Pub. No.: US 2016/0283946 A1
(43) Pub. Date: Sep. 29, 2016

(54) SYSTEM, METHOD, AND ARTICLE FOR MOBILE PAYMENT AND PERSONAL IDENTIFICATION

(71) Applicant: Giovanni Laporta, Watford (GB)

(72) Inventor: Giovanni Laporta, Watford (GB)

(21) Appl. No.: 15/082,924

(22) Filed: Mar. 28, 2016

Related U.S. Application Data
(60) Provisional application No. 62/138,833, filed on Mar. 26, 2015.

(51) Int. Cl. G06Q 20/40; G06K 9/00; G06Q 20/32

(52) U.S. Cl. CPC G06Q 20/40145; G06Q 20/322; G06K 9/00617; G06K 9/00288; G06K 9/00906; G06K 9/00604; G06K 9/00033

(57) ABSTRACT

What is provided is a system, method, and article of manufacture for verifying a user and authenticating a mobile transaction in a more convenient and accurate manner. In some examples, the method comprises registering a user's personal information with the system through a unique identifier; transmitting a request to perform an action, such as a payment transaction, an electronic signing of a document, a remote login into the system, and a transfer of images and/or videos in real-time, corresponding to the unique identifier; capturing biometric information from an image or video of the user; analyzing the biometric information captured from the first user to determine whether the user is a real person; obtaining an indication that the user is verified as a real person; and initiating completion of the action in response to obtaining the indication that the user is verified as a real person.

### PRIORITY CLAIM

This patent application claims priority to and the benefit of the filing date of provisional patent application U.S. Ser. No. 62/138,833 filed on Mar. 26, 2015, which is incorporated herein in its entirety.

### FIELD

This patent application relates to a system, method, and article of manufacture for authenticating mobile transactions by verifying a user's personal identification.

### BACKGROUND

Mobile payment systems offer individuals an alternative to paying with cash, credit cards, or check. Some mobile computing devices (such as cellular phones, tablets, computers, and the like) have begun using virtual representations of the physical cards and contactless payment technology. This technology allows communication between two devices to complete payment transactions at a point of sale (POS) terminal without physical contact or connections. Proximity communication systems, such as Near Field Communication (NFC), allow mobile computing devices to conduct short range contactless payment transactions through radio communication. Mobile computing devices contain software applications that display an electronic barcode to be read by barcode readers at POS terminals to initiate a transaction. The data from the payment card may then be read from the mobile computing device application through the NFC technology.

There are several communication and connection problems that can arise when using virtual cards with a near field communication (NFC) enabled mobile device, though. For example, the interfacing with an NFC enabled mobile device may be particularly difficult due to differences between protocols and message formats between the various types of credit cards and that transactions cannot be sent to a third party for payment through their credit card information. In addition, the strict proximity limitations of the mobile computing device to the point of sale terminal may cause payment transactions to unexpectedly fail. Thus, there is a need for a mobile payment system that can replace cash, credit cards, and checks, while not requiring the user's mobile computing device to be within a close proximity to the point of sale terminal or for the use of physical chips or virtual cards to capture the payment data.

Existing mobile payment systems do not provide a complete and secure solution for sending credit card data through mobile payment communication systems to and from merchants. Typically, a mobile payment system would gather payment information from a user and submit this data to a backend server that then connects to a payment engine. This requires the mobile merchant provider to have proper online connectivity and interface to the payment engine. Thus, the risk of intercepting in-transit data is greatly increased when the NFC technology is used.

Furthermore, various techniques have been developed to deal with user identity fraud issues in online transactions. Some of these techniques include the use of passwords, private keys, and/or iris, face, finger, and voice identity measurement systems. However, passwords and private keys can be readily stolen by others, while iris, face, finger, and voice identity measurement systems often provide inaccurate readings and are difficult to implement with conventional smartphones. Accordingly, there exists a need for a highly secure mobile online transaction system that can conveniently identify a user's identity with a sufficient degree of accuracy.

### SUMMARY

What is provided is a system, method, and article of manufacture for verifying a user's personal identification to authenticate a mobile transaction, such as a payment transaction, in a more convenient and accurate manner. In exemplary embodiments, the system includes at least one mobile computing device comprising a camera for capturing at least one image or video of the user's face, eyes, and/or skin and at least one image or video of the user's payment instrument; the mobile computing device further comprising a display screen for providing visual information to the user through a user interface; a server configured to communicate with the mobile computing device; the server comprising one or more processors and a non-transitory storage medium, the non-transitory storage medium having instructions for communicating with the one or more processors and causing the system to register the user's payment instrument with the system through a unique identifier generated by the system; transmit, via a user interface on the user's mobile computing device, a payment request for a payment transaction; provide an indication for the user to authenticate the payment transaction by entering the unique identifier on the user interface of the user's mobile computing device; capture biometric information from the first image or video of the user taken by the camera on the user's mobile computing device; store the biometric information on the non-transitory storage medium; analyze the biometric information captured from the user to determine whether the user is a real person; obtain an indication from the server that the user is verified as a real person; and initiate completion of the payment transaction in response to obtaining the indication that the user is verified as a real person.

The system may allow one or more users, such as a retailer user or a consumer user, to operate the secure article of manufacture through a user interface on the user's mobile computing device. In addition to managing and conducting payment transactions, the article of manufacture may allow the user to securely authenticate and verify the transactions.

The computer-implemented method for verifying a first user to authenticate a mobile transaction may utilize the article of manufacture on the user's mobile computing device. In exemplary embodiments, the computer-implemented method comprises enrolling a user via the user's mobile computing device in a system for verifying user personal identification; registering the user's personal information with the system through a unique identifier generated by the system; transmitting, via a user interface on the user's mobile computing device, a request to perform an action corresponding to the unique identifier; providing an indication for the user to authenticate the action by prompting the user to enter the unique identifier on the user interface; capturing biometric information from at least one first image or video of the user taken by a camera on the user's mobile computing device; storing the biometric information on a non-transitory storage medium of a server; analyzing the biometric information captured from the user to determine whether the user is a real person; obtaining an indication from the server that the user is verified as a real person; and initiating completion of the action in response to obtaining the indication that the user is verified as a real person. The action may comprise a payment transaction, an electronic signing of a document, a remote login into the system, and a transfer of images and/or videos in real-time.

The payment information may be requested when the web API sends a unique code to the article of manufacture. The payment transaction may only be completed and confirmed through a series of verification and authentication steps performed through the article of manufacture on the user's mobile computing device. The payment information request data is then sent from the article of manufacture to the web API.

### BRIEF DESCRIPTION OF THE DRAWINGS

Subject matter is particularly pointed out and distinctly claimed in the concluding portion of the specification. Claimed subject matter, however, as to structure, organization and method of operation, together with objects, features, and advantages thereof, may best be understood by reference to the following detailed description if read with the accompanying drawings in which:

FIG. 1 is a schematic view of an exemplary system for performing mobile payment transactions and for authenticating a user's personal identification;

FIG. 2 is a front view of an exemplary mobile computing device used with the system of FIG. 1;

FIG. 3 is a flow chart of an exemplary method for performing mobile payment transactions and for authenticating a user's personal identification on a mobile computing device;

FIG. 4 is a flow chart showing of an exemplary method for sending payment information between more than one user and for authenticating the personal identification of each user;

FIG. 5 is a flow chart showing an exemplary method for payment sharing between more than one user and for authenticating the personal identification of each user;

FIG. 6 is a flow chart showing an exemplary method for rewarding a consumer user and for authenticating the consumer user's personal identification;

FIG. 7 is a flow chart showing an exemplary method for opening and storing a tab on the article of manufacture for the consumer user and for authenticating the consumer user's personal identification;

FIG. 8 is a flow chart showing an exemplary method for completing one way personal identification and remote login of a user;

FIG. 9a is a front view of an exemplary user interface on the mobile computing device; and

FIG. 9b is another front view of the user interface on the mobile computing device.

### DETAILED DESCRIPTION

In the following detailed description, numerous specific details are set forth in order to provide a thorough understanding of the examples as defined in the claimed subject matter, and as an example of how to make and use the examples described herein. However, it will be understood by those skilled in the art that claimed subject matter is not intended to be limited to such specific details, and may even be practiced without requiring such specific details. In other instances, well-known methods, procedures, and components have not been described in detail so as not to obscure the examples defined by the claimed subject matter.

Some portions of the detailed description that follow are presented in terms of algorithms and/or symbolic representations of operations on data bits and/or binary digital signals stored within a computing system, such as within a computer and/or computing system memory. An algorithm is here and generally considered to be a self-consistent sequence of operations and/or similar processing leading to a desired result. The operations and/or processing may take the form of electrical and/or magnetic signals configured to be stored, transferred, combined, compared and/or otherwise manipulated. It has proven convenient at times, principally for reasons of common usage, to refer to these signals as bits, data, values, elements, symbols, characters, terms, numbers, numerals and/or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing”, “computing”, “calculating”, “determining” and/or the like refer to the actions and/or processes of a computing platform, such as a computer or a similar electronic computing device that manipulates and/or transforms data represented as physical electronic and/or magnetic quantities and/or other physical quantities within the computing platform's processors, memories, registers, and/or other information storage, transmission, and/or display devices.

Unless specifically stated otherwise, as apparent from the following discussion, it is appreciated that throughout this specification a computing platform includes, but is not limited to, a device such as a computer or a similar electronic computing device that manipulates and/or transforms data represented by physical, electronic, and/or magnetic quantities and/or other physical quantities within the computing platform's processors, memories, registers, and/or other information storage, transmission, reception and/or display devices. Accordingly, a computing platform refers to a system, a device, and/or a logical construct that includes the ability to process and/or store data in the form of signals. Thus, a computing platform, in this context, may comprise hardware, software, firmware and/or any combination thereof. Where it is described that a user instructs a computing platform to perform a certain action, it is understood that “instructs” may mean to direct or cause to perform a task as a result of a selection or action by a user. A user may, for example, instruct a computing platform embark upon a course of action via an indication of a selection, including, for example, pushing a key, clicking a mouse, maneuvering a pointer, touching a touch pad, touching a touch screen, acting out touch screen gesturing movements, maneuvering an electronic pen device over a screen, verbalizing voice commands, and/or by audible sounds. A user may include an end-user.

Flowcharts, also referred to as flow diagrams by some, are used in some figures herein to illustrate certain aspects of some examples. Logic they illustrate is not intended to be exhaustive of any, all, or even most possibilities. Their purpose is to help facilitate an understanding of this disclosure with regard to the particular matters disclosed herein. To this end, many well-known techniques and design choices are not repeated herein so as not to obscure the teachings of this disclosure.

Throughout this specification, the term “system” may, depending at least in part upon the particular context, be understood to include any method, process, apparatus, and/or other patentable subject matter that implements the subject matter disclosed herein. The subject matter described herein may be implemented in software, in combination with hardware and/or firmware. For example, the subject matter described herein may be implemented in software executed by a hardware processor.

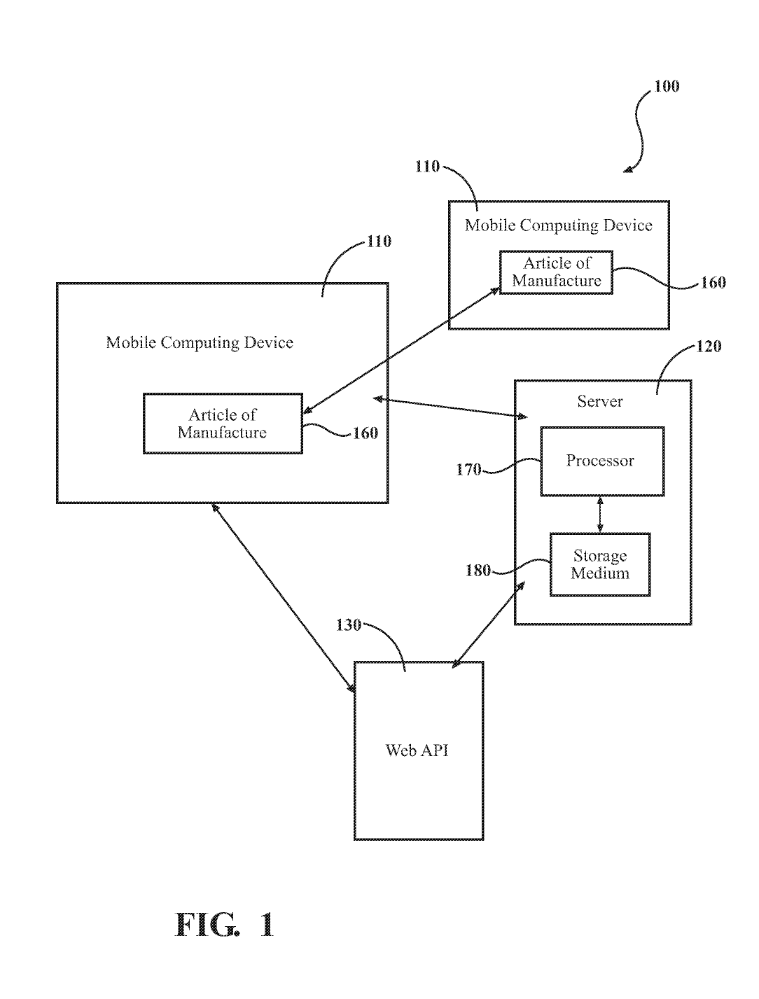

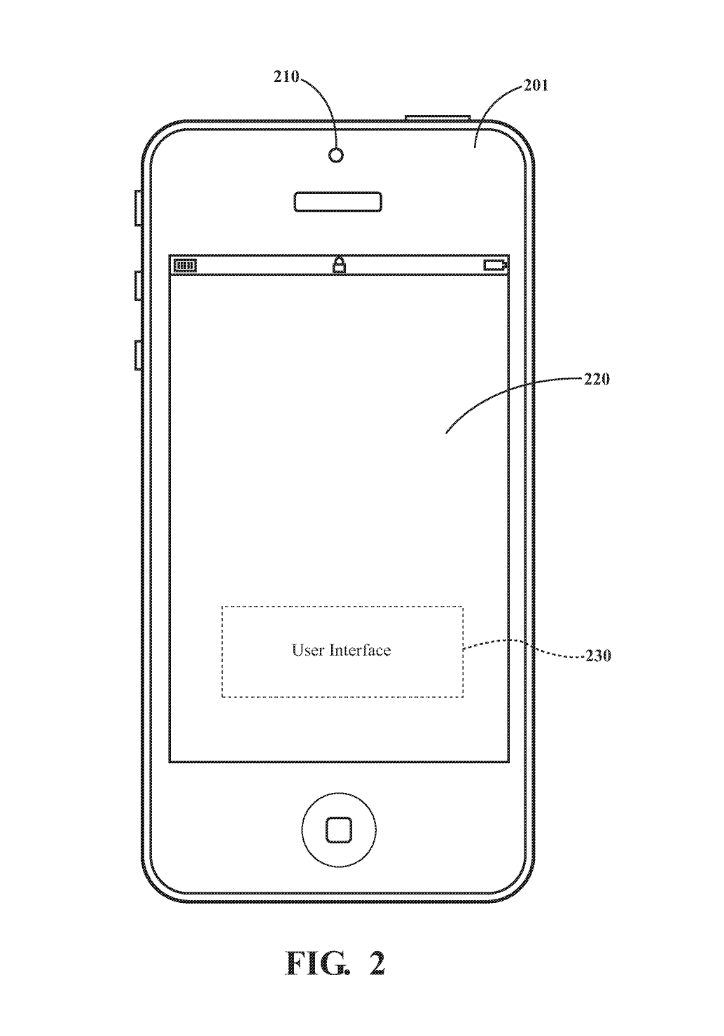

Referring to FIG. 1, FIG. 1 shows an exemplary system 100 for performing mobile payment transactions and for authenticating a user's personal identification. The system 100 includes at least one mobile computing device 110, a server 120, and a web API 130. Each of the least one mobile computing devices 110 may include an article of manufacture 160 allowing the mobile computing device 110 to perform and authenticate payment transactions and to verify a user's personal identification. The system 100 may allow one or more users, such as a retailer user and a consumer user, to operate the secure article of manufacture 160 through a user interface 230 (as shown in FIG. 2) on the at least one the mobile computing device 110.

In some embodiments, the retailer user provides goods and services and operates the article of manufacture 160 on a device for conducting payment transactions, such as the at least one mobile computing device 110. In some embodiments, the consumer user may shop for and purchase the goods and services provided by the retailer user through the article of manufacture 160 on his or her mobile computing device 110. Through the mobile computing device 110, the user may communicate with the server 120 via a two-way data connection. The two-way data connection may be performed over a network, such as a wireless network, a wired network, or a combination thereof. The wireless connection between the user and the server 120 allows for the at least one mobile computing device 110 to communicate with the web API 130 in order for the consumer user to securely make and process online payment requests submitted from the retailer user and for the retailer user to verify that the consumer user is a real human capable of securely completing payment transactions. The web API 130 is the wide area network accessible programming interface through which components of the article of manufacture 160 are accessed.

The server 120 may have one or more processors 170 and a non-transitory storage medium 180 that may have instructions for communicating with the one or more processors 170. The one or more processors 170 may receive data from the user's mobile computing device 110 and execute the instructions by communicating with other mobile computing devices. The storage medium 180 can be fixed or removable.

A service provider (not shown in FIG. 1) provides the secure web API 130 and makes available the instructions for managing the article of manufacture 160. The service provider may manage the activation of and any issues with the article of manufacture 160 associated with a user's account information. In some of the examples described herein, the service provider is known as UOO™.

Referring to FIG. 2, FIG. 2 shows a front view of an exemplary mobile computing device 110 used with the system 100 of FIG. 1. Although a smart phone 201 is shown as an exemplary embodiment of the at least mobile computing device 110, the mobile computing device 110 is not limited to smart phones. Examples of the at least one mobile computing device 110 include, but are not limited to, a smartphone, a smart watch, a tablet personal computer, a notebook computer, a server computer, a personal digital assistant, a handheld device, or any other functionally equivalent mobile computing device known in the art.

The at least on mobile computing device 110 includes a camera 210 capable of capturing digital images. The camera 210 may be configured to capture images of portions of the user's body, including the user's eyes and/or face while the user is using the mobile computing 110. The camera 210 serves to identify biometric features of the user for authenticating the user from the images. The camera 210 may also be configured to capture the user's payment instrument, including the user's credit and debit cards. The camera 210 may be integrated into the at least one mobile computing device 110, such as a front-facing camera or a rear-facing camera that includes a sensor.

The at least on mobile computing device 110 also includes a display screen 220 that may receive input information from a user and provide visual information to the user through a user interface 230. In some embodiments, the user's payment instrument and information may be displayed when the user is making online payments. The user interface 230 may be several different operating systems, including Microsoft Windows®, Apple System 7®, and Mac OS X®. The display screen 220 and the user interface 230 may be used to present any user interface information regarding the systems, methods, and article of manufacture described with reference to FIGS. 1-8, 9a, and 9b.

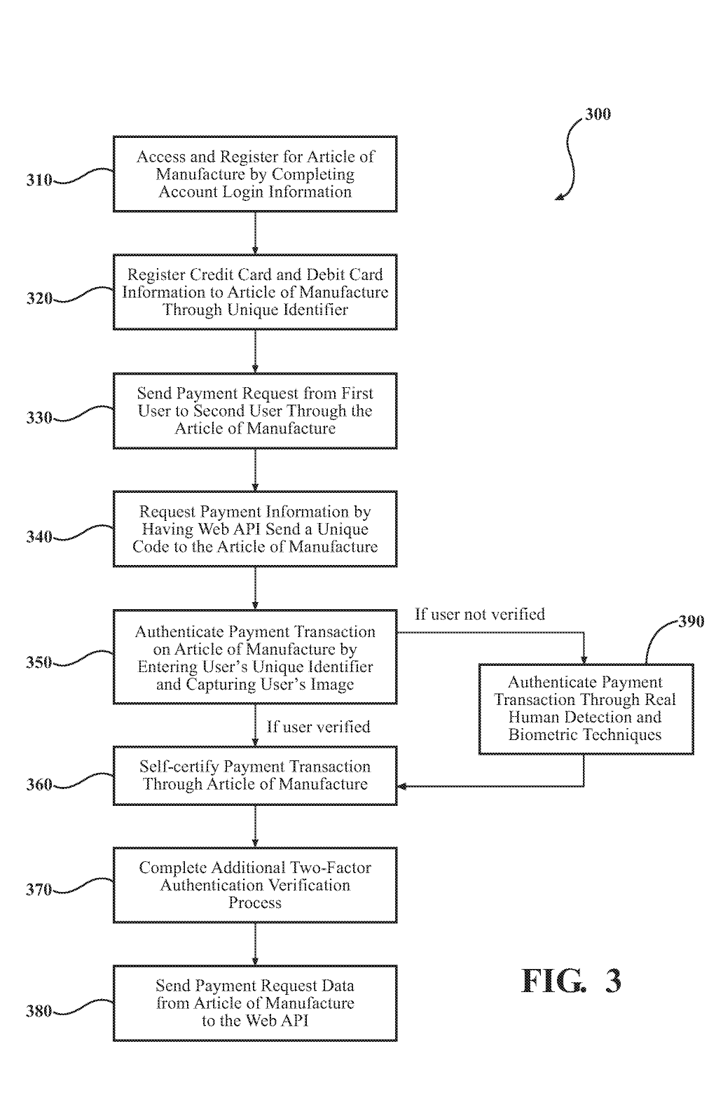

Referring to FIG. 3, FIG. 3 shows an exemplary method 300 for performing mobile payment transactions and for authenticating a user's personal identification on the at least one mobile computing device 110. The method 300 is designed to provide a more convenient and secure method for preventing third parties from stealing the user's personal information and ensuring that the desired users are completing the online payment transactions. The communications involved in this embodiment are exchanged between multiple parties: the consumer user, the retailer user, and the service provider of the server 120 and the article of manufacture 160. In other embodiments, additional parties may also be involved in the mobile payment transaction and personal authentication method by performing various services, such as payment processing.

The method 300 may begin at block 310, where the user accesses the article of manufacture 160 and registers for its service by completing the necessary login information to create a secure account. In some of the examples described herein, the user may include additional data, such as the desired payment methods, social media information, or other data that may affect the performance or usability of the article of manufacture 160. The article of manufacture 160 may be available to download to the mobile computing device 110 via an “app store” or other functionally equivalent ways. The user stores his or her personal information, including debit and credit card information with the article of manufacture 160 and receives a personal identification number (PIN) and/or other unique identifier from the server 120. This data may be stored with varying levels of security on the server 120. The unique identifier provided to the user corresponds to a variety of predetermined tasks, such as, but not limited to conducting payment transactions, signing documents, and sharing images or videos in real-time via the user's mobile computing device 110. After the user enters the unique identifier into the article of manufacture 160 through the user interface 230, the article of manufacture 160 allows the user to access a customized, hidden interface; identifies the predetermined task(s) to be performed; and determines the specific authentication steps needed to be performed by the user to carry out the predetermined tasks.

In block 320, the user may register his or her credit and/or debit card information with the article of manufacture 160 by using his or her PIN and/or unique identifier. In some embodiments, the user's credit and/or debit cards may be registered by augmented reality software on the article of manufacture 160 of the user's mobile computing device 110. The user may take digital images of his or her credit and/or debit cards using the camera 210 on the mobile computing device 110 and incorporate the digital images into the article of manufacture 160 through the user interface 230. In addition to processing the user's payment information, the article of manufacture 160 simultaneously triggers the camera 210 on the mobile computing device 110 to capture a digital image of the user's face. During the registration process, the article of manufacture 160 may also request and process the user's post/zip code, which is linked to the user's payment instrument. In order to prevent duplicate payment card registration with the article of manufacture 160, payment cards are only registered once per user within the article of manufacture 160. The registration of credit and debit card information to the article of manufacture 160 may allow the user to make payments from any location in the world where the payment method is accepted.

In block 330, a user, such as a retailer user, may use his/her mobile computing device 110 and a unique identifier provided by the article of manufacture 160 to send a payment request to a unique identifier of a second user, such as a consumer user. The article of manufacture 160 displays information about the transaction to be completed by the consumer user, such as the goods or services to be purchased, the price of each, and the total price for the transaction. In some embodiments, the consumer user may use other methods of payment, such as pre-paid cards, gift cards, or coupons, on the article of manufacture 160 to complete a proposed transaction with the retailer user.

In block 340, online payments accepted by the article of manufacture 160 may only be requested when payment information is transmitted through the web API 130. In some of the examples described herein, the web API 130 is known as UOO™ The web API 130 may send a unique code or unique identifier to the article of manufacture 160 via wireless connection to communicate that the payment request is an online payment. In some of the examples described herein, the unique code or the unique identifier is known as UOO CODE™.

The user may then confirm and complete the payment transaction through the mobile computing device 110, as shown in block 350. In some examples, the user may employ the user interface 230 and the article of manufacture 160 to monitor each item on the bill, calculate a tip for the bill, enter an additional amount on the bill, such as a tip, and then pay the bill from the user's mobile computing device 110. In addition to entering the unique identifier on the user interface 230 of the mobile computing device 110 in order to allow the user access to a hidden interface on the article of manufacture 160, the user's photo may be taken using the camera 210 of the mobile computing device 110. As a result, a real human face may be differentiated from an attempt to spoof the article of manufacture 160 using, for example, a photograph or video of a face. If the user is verified as being a real person through the input of his/her unique identifier and the image of the user, the article of manufacture 160 may authenticate and complete the online payment transaction.

If the user is not verified as a real person using the photo capture option of with the camera 210, other embodiments of real human detection may be used, such as voice and motion detectors, proximity sensors, focus sensors, ambient light sensors, augment reality analysis, and glare and reflection detection, as shown in block 390. At least one second image or video of the user may be taken by the camera 210 of the user's mobile computing device 110 to capture additional biometric information, such as facial recognition information, retinal recognition information, movement detection information, voice recognition information, and/or light reflection information. In some embodiments, the article of manufacture 160 may analyze and record a reflected light signal of the user captured by the camera 210. In some embodiments, the article of manufacture 160 may cause a white, color, infrared light to flash from a light source on the display screen 220 of the user's mobile computing device 110. In alternative embodiments, the light source may be external from the user's mobile computing device 110. The article of manufacture 160 may record the reflected light (red, green, and/or blue) emitted from a user's skin, with each color corresponding to a different wavelength. The reflected light signal will result in a different light wavelength for a real human than from a pre-recorded video on an LCD screen. As a result, the article of manufacture 160 may use a combination of the embodiments disclosed herein to determine that a photo being taken for authentication is of a real person and not of a still photo or pre-recorded video.

In the voice and motion detection embodiment, the article of manufacture 160 looks for facial gesture and/or a trigger word when the article of manufacture 160 randomly requests the user to speak and/or make a specific facial gesture, such as a wink, or smile. If the predetermined value set by the article of manufacture 160 does not match the user's response, the article of manufacture 160 may determine that the photo being taken of the user is not of a real person and may not allow the authentication process to automatically capture or complete.

In the proximity sensor embodiment, the camera 210 software in the article of manufacture 160 is used for measuring the distance between the front of the mobile computing device 110 and an object when taking a photo for authentication of a user. If the distance does not fall into the predetermined value set by the article of manufacture 160, the article of manufacture 160 may determine that the photo being taken of the user is not of a real person and may not allow the authentication process to auto capture or complete. The proximity value may be determined by a number of factors, such as the object's features and the distance of the object.

In the focus sensor embodiment, the camera software in the article of manufacture 160 is used for measuring depth of foreground and background together with facial features to determine the difference between the 3-dimensional and 2-dimensional depth when taking a photo. If the focus does not fall into the predetermined value set by the article of manufacture 160, the article of manufacture 160 may determine that the photo being taken of the user is not of a real person and may not allow the authentication process to auto capture or complete.

In the ambient light sensor embodiment, the camera software in the article of manufacture 160 is used for measuring light emitted from the LCD backlight that may be placed in front of it, such as backlight from a TV, computer screen, or another mobile device when taking a photo. If the article of manufacture 160 detects a light emitting device in front of the mobile computing device 110 when taking an authentication photo, the article of manufacture 160 will determine the light is false and being taken of the user is not of a real person and may not allow the authentication process to auto capture or complete.

In the augmented reality embodiment, the article of manufacture 160 is used for measuring recognized image layers and depth set by the article of manufacture 160 when analyzing captured images taken by the camera 210. In order to accurately measure depth, the user may be asked by the article of manufacture 160 to move closer or further away from the camera 210, while the background remains still. If the article of manufacture 160 determines that the user is not a real person, the article of manufacture 160 will prevent the authentication process from auto capturing additional images and completing.

In the glare and reflection detection embodiment, the camera software in the article of manufacture 160 is used for measuring the glare or reflection emitted by other electronic devices in front of the mobile computing device 110. If the article of manufacture 160 detects there is such a device in front of the mobile computing device 110 when taking an authentication photo, the article of manufacture 160 will determine that the user is not a real person and may not allow the authentication process to auto capture or complete.

In block 360, the article of manufacture 160 may provide for a self-certification process, where the article of manufacture 160 may not become active for online payments until the consumer user has made at least five (5) individual payments to at least five (5) different retailer users using the same article of manufacture 160 through the consumer user's unique identifier. The more that a consumer user uses the article of manufacture 160 for conducting payment transactions, the more secure the article of manufacture 160 becomes. In some embodiments, about five different payments to about five different retailer users using the same article of manufacture 160, the article of manufacture 160 provider may establish that the consumer user is a real human, the photos are accurate representations of the consumer users, and that the registered payment cards are legitimate.

In block 370, the article of manufacture 160 may complete a two-factor authentication process for the online payments, where the first factor is confirming the validation of an authentic code or unique identifier that the user has specifically entered into the article of manufacture 160 and the second factor is verifying that the user has completed the article of manufacture 160 self-certification program. In another embodiment, the article of manufacture 160 may also verify the specific geolocation of the user. The article of manufacture 160 may identify the user's location and upload the location, along with a photo of the user, and the user's unique identifier to the mobile computing device 110. When a consumer user pays through online payment transactions, there are significant advantages of uploading the user's location to the user interface 230, instead of simply relying on NFC or (POS) terminals.

In block 380, once the user has been successfully verified, the article of manufacture 160 on the user's mobile computing device 110 sends the payment request data securely over HTTPS to the web API 130 for payment processing. The web API 130 receives the payment data and passes this information forward to a payment processor. In some of the examples described herein, the payment is processed by the service provider's web API 130. In other examples, the payment processing may involve the use of third-party payment processors.

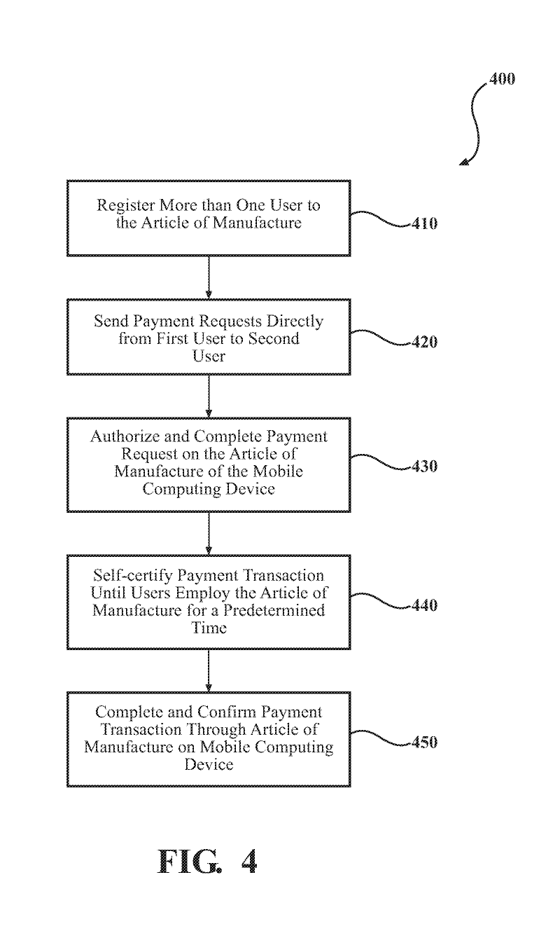

Referring to FIG. 4, FIG. 4 shows an exemplary method 400 for sending payment information between more than one user and for authenticating the personal identification of each user. In this method 400, each user has the same article of manufacture 160. In block 410, the first user may register with the article of manufacture 160 through a mobile computing device 110 and then register a second user, with the second user's express permission, to the same article of manufacture 160. Once the second user's credit card information is registered with the article of manufacture 160, the first user may then directly send bills and payments through the article of manufacture 160 to the second user, who may be located anywhere in the world, as shown in block 420. For example, the first user may request that a second user pay for goods and/or services on behalf of the first user through the article of manufacture 160 on the second user's own mobile computing device 110.

In block 430, the second user may then authorize and complete the online payment transaction through the authentication process on the article of manufacture 160. In block 440, the article of manufacture 160 provides for a self-certification process, where the article of manufacture 160 may not become active for online payments until the first user and second user both use the article of manufacture 160 for a predetermined number of times. In certain examples described herein, the authentication process from FIG. 3 may also be used in this embodiment 450. In some of the examples described herein, the method 400 is known as UOO AWAY PAY™.

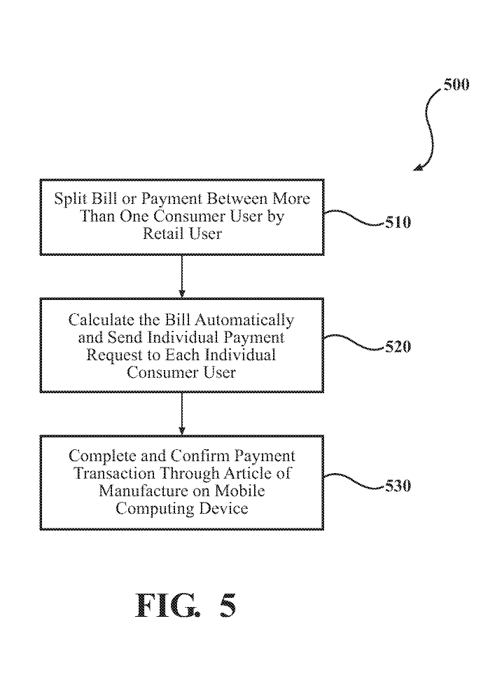

Referring to FIG. 5, FIG. 5 shows an exemplary method 500 or payment sharing between more than one user and for authenticating the personal identification of each user. In this method 500, each user has the same article of manufacture 160 on their respective mobile computing device 110. In step 510, a retailer user can decide to split the bill or payment between more than one consumer user. The article of manufacture 160 may allow the retailer user to request information from each of the more than one consumer users, such as the unique identifier for each consumer user and the amount the bill or payment that needs to be split by the retailer user. Once the distribution split is determined, the article of manufacture 160 may calculate the bill automatically and send individual payment requests to each consumer user for their individual payment approval, as shown in block 520. The online payments may be approved in the same way by each consumer user through the article of manufacture's 160 authentication process on his/her own mobile computing device 110. In certain examples described herein, the authentication process from FIG. 3 may also be used in this method 500. In some of the examples described herein, this method 500 is known as UOO SHARE PAY™.

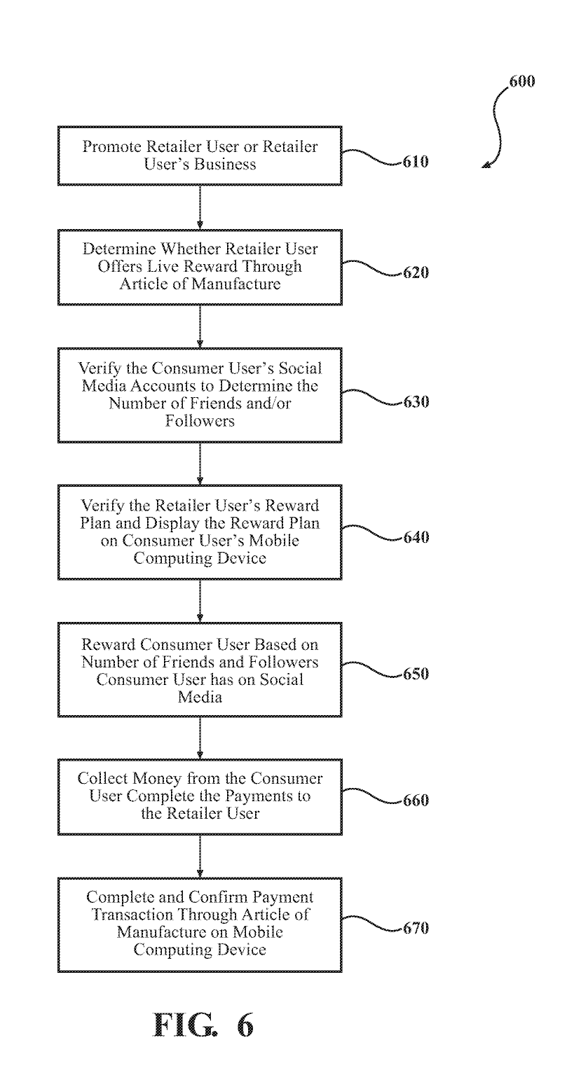

Referring to FIG. 6, FIG. 6 shows an exemplary method 600 for rewarding a consumer user and for authenticating the consumer user's personal identification 600. Examples of ways that the consumer user may provide the benefit to the retailer user include through social media, online surveys, promotions, and drawings, shown in block 610. In some of the examples described herein, the consumer user may promote the retailer user and their respective business on various forms of social media, such as Facebook®, Twitter®, Instagram®, LinkedIn®, Google Plus+®, Pinterest®, etc., by publicly posting positive information about the retailer user and his or her business. In some embodiments, this posting may occur through an auto feed posting. The reward or discount that the retailer user provides to the consumer user is determined by various factors, such as the number of friends or followers the consumer user has on social media and the amount of the bill. The greater the amount of friends or follower and the greater the amount of the bill, the higher percentage of discount that a consumer user can achieve. For example, a retailer user may discount the bill by 10% to the consumer user if the consumer user has at least 20,000 followers on his/her social media account and the bill is at least $300. The retailer user may determine the specific factors and criteria necessary for rewarding the consumer user through the retailer user's account on the article of manufacture 160.

In block 620, the article of manufacture 160 may first determine whether the retailer user has a live reward offer for the consumer user. In some embodiments, the live reward offer may be advertised by the retailer user through channels such as radio advertisements. Radio advertisements may allow the retailer use to reach a larger or more targeted consumer audience. If the retailer user has or advertises for a live reward offer, the article of manufacture 160 may automatically verify the consumer user's social media accounts to determine the number of friends and/or followers associated with the consumer user, as shown in block 630. In block 640, the article of manufacture 160 may verify the retailer user's reward plan/process for each public social media posting and may display the reward plan/process on the consumer user's mobile computing device 110 through the user interface 230. The rewards may be in various forms, including monetary. In block 650, if the reward is monetary, the article of manufacture 160 directly deducts the amount from the bill before final payment is made by the consumer user. For non-monetary rewards, no reward will be provided to the consumer user until the consumer user completes his or her payment obligations to the retailer user. In block 660, the retailer user may either collect money directly from the consumer user or allow a third party to collect the money directly from the consumer user and complete the payments to the retailer user. In certain examples described herein, the authentication process from FIG. 3 may also be used in this method 600. In some of the examples described herein, this method 600 is known as UOO SOCIAL PAY™.

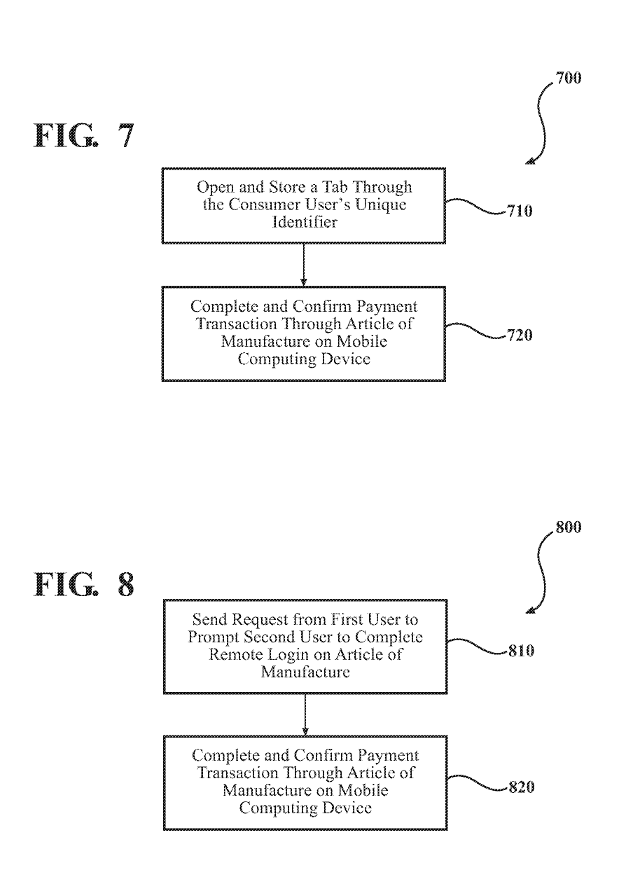

Referring to FIG. 7, FIG. 7 shows an exemplary method 700 for opening and storing a bill tab on the article of manufacture 160 for the consumer user and for verifying the personal identification of the consumer user. The retailer user may open and store a bill tab by specifically using the consumer user's unique identifier 710. The article of manufacture 160 tracks how much money is being spent by a specific consumer user and allows the consumer user to conveniently pay his/her bill when the consumer user is finished making transactions with that specific retailer user. The consumer user may independently decide when to close his or her tab with a specific establishment and to complete the payment transaction through the mobile computing device 110 anywhere in the world. In certain examples described herein, the authentication process from FIG. 3 may also be used in this method 700. In some of the examples described herein, this method 700 is known as UOO TAB™.

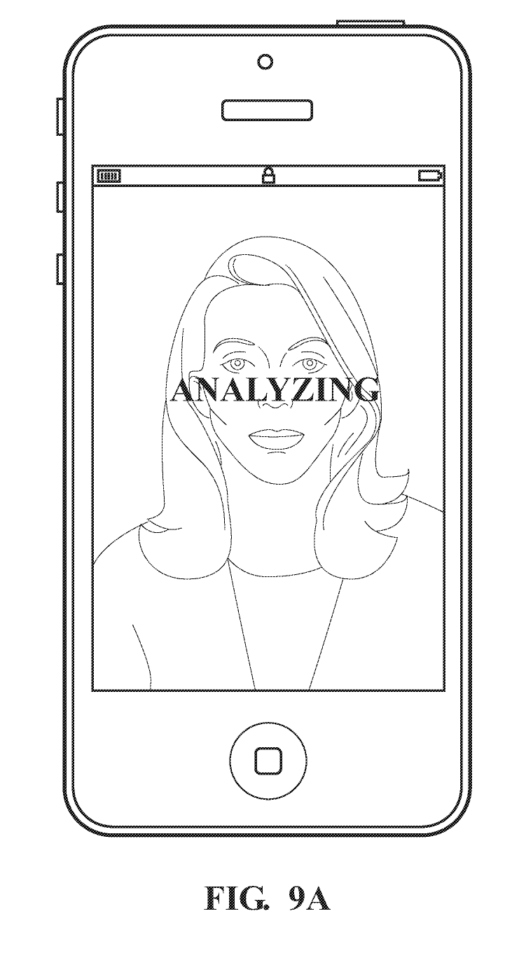

Referring to FIG. 8, FIG. 8 shows an exemplary method 800 for completing one way personal identification and remote login of a user. In block 810, through a user's unique identifier, online websites may send a request to the article of manufacture 160 prompting the user to complete a remote login. A user may complete the login process using their mobile computing device 110 through the same authentication process used in the online payment embodiments disclosed above, as shown in 820. Some of the applications of this exemplary embodiment include door and turnstile entry systems. In certain examples described herein, the authentication process from FIG. 3 may also be used in this embodiment. In some of the examples described herein, this method 800 is known as UOO PASS™.

In another embodiment of the system 100, a user may donate money to charity when paying for a bill through the article of manufacture 160. In some of the examples described herein, this method is known as UOO DONATION PAY™. During a transaction between a consumer user and a retailer user, the article of manufacture 160 may automatically round the bill to the nearest whole number. The difference between the actual amount and the rounded-number may then be donated by the consumer user to charity. However, consumer users may increase the amount to donate to charity, if they choose.

In yet another embodiment, a user may send business and personal documents to another user through the article of manufacture 160 for approval, review, and/or execution. The user may review, approve, and electronically sign documents. The delivery address of the user may be authenticated upon sending of the documents. In certain examples described herein, the authentication process from FIG. 3 may also be used in this embodiment In some of the examples described herein, this method is known as UOO SIGN™.

In another embodiment, a user may perform a two-way identification check through each user's unique identifier for the article of manufacture 160. Users can complete identification checks through their respective mobile computing devices 110 by using the same authentication process from FIG. 3, but without conducting any payment transactions. Some example applications for this specific embodiment include online dating or social media sites, purchasing merchandise online from unknown sellers, or simply confirming an individual's identity or deliver address for shipments or transactions. In some of the examples described herein, this method is known as UOO RATE™.

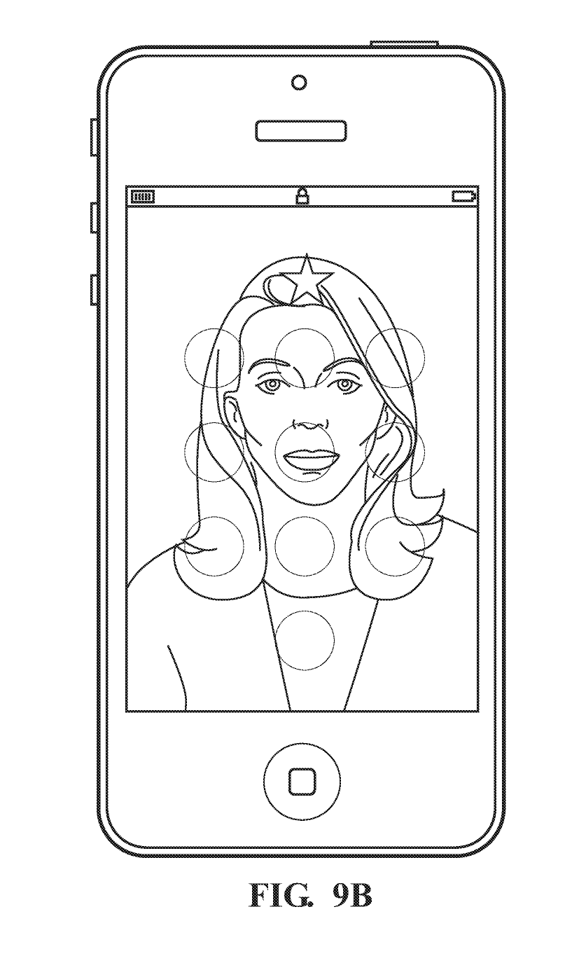

Referring to FIGS. 9a and 9b, both figures show an exemplary representation of a user interface 230 displayed on the consumer user's mobile computing device 110 through the article of manufacture 160. The display screen 220 shows many of the functions possible from the article of manufacture 160. The user interface 230 may enable or disable the payment transaction and personal verification services on the article of manufacture 160. On this mock display screen 220, some of the functions displayed include the real human detection of the user by capturing of the user's photo using the camera 210 of the mobile computing device 110 (as shown in FIG. 9a) and by having the user enter his or her unique identifier on the user interface 230 of the mobile computing device 110 (as shown in FIG. 9b). Once the user is verified through the input of his or her unique identifier and the user's photo, then the article of manufacture 160 may authenticate and complete the online payment transaction.

In some examples, the article of manufacture 160 may include one or more functions that enable it to evaluate retailer users. The article of manufacture 160 may be configured to receive feedback from users, such as complaints and compliments, through various forms, such as a scoring or rating function through the user interface 230. In some examples, the user may quantitatively rate the retailer user or the retailer user's place of business based on various factors, such as costs, service, and reliability. The score may affect how other users interact with the retailer use through the article of manufacture 160.

In addition to the foregoing, various aspects or features described herein can be implemented as a method, system, or article of manufacture using standard programming and/or engineering techniques. The term “article of manufacture” as used herein is intended to encompass a computer program accessible from any computer-readable device, carrier, or media. For example, computer-readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally, various storage media described herein can represent one or more devices and/or other machine-readable media for storing information.

The article of manufacture that may be used with the systems and methods described herein according to one or more examples, although the scope of claimed subject matter is not limited in this respect. The article of manufacture may include more and/or fewer components than those discussed herein; however, generally conventional components may not be shown. The article of manufacture may be used to employ tangibly all or a portion of FIGS. 1-8, 9a, and 9b, and/or other processes disclosed herein.

It will, of course, be understood that, although particular embodiments have just been described, the claimed subject matter is not limited in scope to a particular embodiment or implementation. Likewise, an embodiment may be implemented in any combination of systems, methods, or products made by a process, for example.

In the preceding description, various aspects of claimed subject have been described. For purposes of explanation, specific numbers, systems, and/or configurations were set forth to provide a thorough understanding of claimed subject matter. Computer file types and languages, and operating system examples have been used for purposes of illustrating a particular example. However, it should be apparent to one skilled in the art having the benefit of this disclosure that claimed subject matter may be practiced with many other computer languages, operating systems, file types, and without these specific details. In other instances, features that would be understood by one of ordinary skill were omitted or simplified so as not to obscure claimed subject matter. While certain features have been illustrated or described herein, many modifications, substitutions, changes or equivalents will now occur to those skilled in the art. It is, therefore, to be understood that claims are intended to cover all such modifications or changes as fall within the true spirit of claimed subject matter.

1. A system for user verifying a user and authenticating a mobile transaction, the system comprising:
at least one mobile computing device comprising a camera for capturing at least one image or video of a user's face, eyes, and/or skin and at least one image or video of a payment instrument of the user; the mobile computing device further comprising a display screen for providing visual information to the user through a user interface; a server configured to communicate with the mobile computing device; the server comprising one or more processors and a non-transitory storage medium, the non-transitory storage medium having instructions for communicating with the one or more processors and causing the system to:
register the payment instrument with the system through a unique identifier generated by the system;
transmit, via a user interface on the user's mobile computing device, a payment request for a payment transaction;
provide an indication for the user to authenticate the payment transaction by prompting the user to enter the unique identifier on the user interface;
capture biometric information from the image or video of the user's face, eyes, and/or skin taken by the camera on the user's mobile computing device;
store the biometric information on the non-transitory storage medium;
analyze the biometric information captured from the user to determine whether the user is a real person;
obtain an indication from the server that the user is verified as a real person; and initiate completion of the payment transaction in response to obtaining the indication that the user is verified as a real person.

2. The system of claim 1, the system configured to capture biometric information from at least one second image or video of the user, the second image or video recorded by the camera of the user's mobile computing device.

3. The system of claim 2, the biometric information comprises facial recognition information, retinal recognition information, movement detection information, voice recognition information, and/or light reflection information.

4. The system of claim 3, the light reflection information is obtained from the emission of colors from the user's skin, the emission of colors corresponds to a specific wavelength of light.

5. The system of claim 1, prior to initiating completion of the payment transaction, confirming that the user has completed a predetermined amount of payment transactions to a predetermined amount of different retailer users through the unique identifier provided to the user by the system.

6. The system of claim 5, the predetermined amount of payment transactions is at least five and the predetermined amount different retailer users is at least five.

7. The system of claim 1, the payment instrument comprises credit cards, debit cards, gift cards, or pre-paid cards.

8. A computer-implemented method for user verification, the method comprising:
enrolling a first user via the first user's mobile computing device in a system for verifying user personal identification;
registering the first user's personal information with the system through a unique identifier generated by the system;
transmitting, via a user interface on the first user's mobile computing device, a request to perform an action corresponding to the unique identifier;
providing an indication for the first user to authenticate the action by prompting the user to enter the unique identifier on the user interface;
capturing biometric information from at least one first image or video of the first user taken by a camera on the first user's mobile computing device;
storing the biometric information on a non-transitory storage medium of a server;
analyzing the biometric information captured from the first user to determine whether the first user is a real person;
obtaining an indication from the server that the first user is verified as a real person; and
initiating completion of the action in response to obtaining the indication that the first user is verified as a real person.

9. The computer-implemented method of claim 8, the action comprising a payment transaction, an electronic signing of a document, a remote login into the system, and a transfer of images and/or videos in real-time.

10. The computer-implemented method of claim 8, the first image or video of the first user includes an image or video of the first user's face and the biometric information comprises facial recognition information.

11. The computer-implemented method of claim 8, further comprising:
if the first user is not verified as a real person from the first image or video, capturing biometric information from at least one second image or video of the first user, the second image or video recorded by the camera of the first user's mobile computing device.

12. The computer-implemented method of claim 11, the second image or video of the first user includes an image or video of the first user's face, body, eyes, and/or skin and the biometric information comprises facial recognition information, retinal recognition information, movement detection information, voice recognition information, and/or light reflection information.

13. The computer-implemented method of claim 12, further comprising:
identifying the specific wavelength of light corresponding to the color emitted from the light reflection off the first user's skin.

14. The computer-implemented method of claim 9, further comprising:
prior to initiating completion of the payment transaction, confirming that the first user has completed a predetermined amount of payment transactions to a predetermined amount of different retailer users through the unique identifier provided to the first user by the system.

15. The computer-implemented method of claim 14, the predetermined amount of payment transactions is at least five and the predetermined amount different retailer users is at least five.

16. The computer-implemented method of claim 8, the first user's personal information comprises a payment instrument, the payment instrument comprises credit cards, debit cards, gift cards, and/or pre-paid cards.

17. The computer-implemented method of claim 9, further comprising:
enrolling a second user via the second user's mobile computing device in the system;
registering a payment instrument of the second user with the system through a unique identifier generated by the system;
transmitting a payment request from the first user to the second user for payment through the second user's mobile computing device;
providing an indication for the second user to authenticate the payment transaction by prompting the second user to enter the unique identifier on the second user's mobile computing device;
capturing biometric information from at least one first image or video of the second user taken by a camera on the second user's mobile computing device;
storing the biometric information on the non-transitory storage medium of the server;
analyzing the biometric information captured from the second user to determine whether the second user is a real person;
obtaining an indication from the server that both the first user and second user are verified as real people; and
initiating completion of the payment transaction in response to obtaining the indication both the first user and second user are verified as real people.

18. The computer-implemented method of claim 9, further comprising:
providing an indication to the first user that a retailer user offers a reward to the first user for promoting the business of the retailer user by publicly posting information on at least one of the first user's social media accounts;
transmitting information to the retailer user regarding the amount of friends or followers associated with at least one of the first user's social media accounts; and
displaying information to the first user's mobile computing device regarding the details of the reward offered by the retailer user.

19. The computer-implemented method of claim 18, the reward comprises a financial reduction in the amount owed by the first user to the retailer user during the payment transaction, the reduction in the amount is determined by the number of friends or followers associated with at least one of the first user's social media accounts and the amount of the payment request.

20. The computer-implemented method of claim 9, further comprising:
providing an indication to the first user that the first user may schedule a payment to charity during the completion of the payment transaction;
automatically rounding the payment amount to the nearest whole number and displaying the actual payment amount and rounded payment amount for the first user; and initiating payment to charity of the difference between the actual payment amount and the rounded payment amount, if indicated as approved by the first user.

21. A non-transitory article of manufacture having instructions stored thereon, which if executed, cause a computing platform to implement a method comprising:
enrolling a user via the user's mobile computing device in a system for verifying user personal identification to authenticate a mobile transaction;
registering a payment instrument of the user with the system through a unique identifier generated by the system;
transmitting, via a user interface on the user's mobile computing device, a payment request for a payment transaction;
providing an indication for the user to authenticate the payment transaction by entering the unique identifier on the user interface of the user's mobile computing device;
capturing biometric information from at least one image or video of the user taken by a camera on the user's mobile computing device;
storing the biometric information on a non-transitory storage medium of a server;
analyzing the biometric information captured from the user to determine whether the user is a real person;
obtaining an indication from the server that the user is verified as a real person; and
initiating completion of the payment transaction in response to obtaining the indication that the user is verified as a real person.
